(19) United States
(12) Patent Application Publication
(10) Pub. No.: US 2012/0127234 A1
(43) Pub. Date: May 24, 2012

(54) AQUEOUS INK

(75) Inventors: Atsuhito Yoshizawa, Kawasaki-shi (JP); Taketoshi Okubo, Asaka-shi (JP); Ikuo Nakazawa, Kawasaki-shi (JP); Shoji Koike, Yokohama-shi (JP)

(73) Assignee: CANON KABUSHIKI KAISHA, Tokyo (JP)

(21) Appl. No.: 13/387,349

(22) PCT Filed: Jul. 13, 2010
(86) PCT No.: PCT/JP2010/004546

§ 371 Date: Jan. 26, 2012

(30) Foreign Application Priority Data
Jul. 31, 2009 (JP) 2009-179633
Jun. 7, 2010 (JP) 2010-130296

(51) Int. Cl. B41J 2/015; C09D 11/02

(52) U.S. Cl. 347/20; 106/31.6

(57) ABSTRACT

The present invention relates to an aqueous ink having a surface tension of 34 mN/m or less including a self-dispersion pigment and water. In the aqueous ink, the self-dispersion pigment has a plurality of pKa values that are 8.0 or less. Assuming that the lowest pKa value among the plurality of pKa values is pKa₁ and the highest pKa value among the plurality of pKa values is pKa₂, pKa₁ and pKa₂ satisfy Mathematical formula (1), and the pH value of the aqueous ink satisfies Mathematical formula (2).

### TECHNICAL FIELD

The present invention relates to an aqueous ink.

### BACKGROUND ART

High permeability to plain paper is required for an aqueous ink supplied to a recording medium by an inkjet recording method or the like. Furthermore, a recorded image obtained on plain paper needs to have high image density.

For such demands, PTL 1 discloses a super-permeability aqueous ink having a surface tension of 34 mN/m or less that uses a phosphonic acid-type self-dispersion pigment as a coloring material. With such an aqueous ink, solid-liquid separation satisfactorily occurs after the ink lands on plain paper as a result of the combined effect of a coloring material and an ammonium salt of an organic carboxylic acid that is used in the ink together with the coloring material. Thus, the image density of a recorded image is increased by holding the coloring material in the outer layer of plain paper while the permeability of an ink to plain paper is increased.

However, although the aqueous ink disclosed in PTL 1 is satisfactory in terms of the permeability to plain paper and the image density of a recorded image, there is still room for improvement in terms of also achieving the dispersion stability of an ink.

### CITATION LIST

### Patent Literature

PTL 1: WO2009/014242

PTL 2: U.S. Pat. No. 4,723,129

PTL 3: U.S. Pat. No. 4,740,796

### SUMMARY OF INVENTION

Accordingly, the present invention provides an aqueous ink that has high permeability to plain paper, achieves high image density of an recorded image, and has satisfactory dispersion stability.

In the present invention, an aqueous ink having a surface tension of 34 mN/m or less includes a self-dispersion pigment and water, wherein the self-dispersion pigment has a plurality of pKa values that are 8.0 or less; assuming that the lowest pKa value among the plurality of pKa values is pKa₁ and the highest pKa value among the plurality of pKa values is pKa₂, pKa₁ and pKa₂ satisfy Mathematical formula (1) below; and a pH value of the aqueous ink satisfies Mathematical formula (2) below.

[Math.1]

2.0≦pKa₂−pKa₁ (1)

[Math.2]

pKa₂−1.5≦pH≦pKa₂+0. 5 (2)

The aqueous ink of the present invention has high permeability to plain paper, achieves high image density of an recorded image, and has satisfactory dispersion stability.

### BRIEF DESCRIPTION OF DRAWINGS

FIG. 1 shows the dissociative state of a self-dispersion pigment.

FIG. 2A shows the state of solid-liquid separation of an aqueous ink in plain paper.

FIG. 2B shows the state of solid-liquid separation of an aqueous ink in plain paper.

FIG. 3 shows an example of a method for forming recording dots.

FIG. 4 shows an example of a recording head.

FIG. 5 shows an example of an inkjet recording apparatus.

### DESCRIPTION OF EMBODIMENT

The inventors of the present invention have conducted research in the case where a self-dispersion pigment is used as a coloring material in an aqueous ink. The dissociative state of a hydrophilic group bonded to the self-dispersion pigment changes in accordance with the pH of the ink. Thus, the inventors have found that, by adjusting the pH of an ink containing a certain self-dispersion pigment, there can be produced an ink that has high permeability to plain paper, achieves high image density of an recorded image, and has satisfactory dispersion stability. The present invention will now be described in detail with a suitable embodiment.

### Aqueous Ink

In the aqueous ink of the present invention, a self-dispersion pigment is used as a coloring material. With a self-dispersion pigment, solid-liquid separation smoothly occurs after the ink is supplied to a recording medium and the pigment itself does not easily permeate plain paper deeply, compared with the case where, for example, a polymer dispersion pigment is used. Consequently, the image density becomes high.

Such a self-dispersion pigment basically does not require a dispersant and is a pigment that includes a hydrophilic group bonded to the surface thereof directly or through other atomic groups so as to be soluble in water. Various known pigments disclosed in PTL1 can be used as a pigment to which a water-soluble property is to be imparted. A hydrophilic group introduced into the self-dispersion pigment that uses such a pigment as a raw material may be directly bonded to the surface of the pigment or may be indirectly bonded to the surface of the pigment by interposing other atomic groups between the hydrophilic group and the surface of the pigment.

In the self-dispersion pigment obtained by bonding a hydrophilic group to the surface of a pigment directly or through other atomic groups, a proton of a dissociative group in the hydrophilic group is dissociated at a certain pH value. Thus, a self-dispersion pigment is stably dispersed in the ink without using a dispersant such as a polymer or a surfactant.

The self-dispersion pigment of the present invention has a plurality of pKa values that are 8.0 or less. Assuming that the lowest pKa value among the plurality of pKa values is pKa₁ and the highest pKa value among the plurality of pKa values is pKa₂, pKa₁ and pKa₂ satisfy Mathematical formula (1) below.

[Math.3]

2.0≦pKa₂−pKa₁ (1)

Furthermore, by adjusting the pH of the aqueous ink containing such a self-dispersion pigment, there can be provided an aqueous ink that has high permeability to plain paper, achieves high image density of an recorded image, and has satisfactory dispersion stability.

In the case where a self-dispersion pigment has a plurality of pKa values, there are two aspects described below. One of the aspects is that the self-dispersion pigment has one kind of hydrophilic group and the one kind of hydrophilic group has a plurality of pKa values. The other of the aspects is that the self-dispersion pigment has two or more kinds of hydrophilic groups and the hydrophilic groups have pKa values different from each other. Examples of the hydrophilic group of the former include —PO₃(M)₂ and -Ph(COOM)ₙ (where Ph is a phenyl group, M is one independently selected from a hydrogen atom, an alkali metal, ammonium, and an organic ammonium, and n is 2 or 3). Herein, the pKa values of phosphonic acid are 7.20 and 2.15. The pKa values of phthalic acid are 5.41 and 2.95. The pKa values of 1,2,3-benzenetricarboxylic acid are 5.87, 4.20, and 2.80. When such a substance is introduced into the surface of a pigment as a hydrophilic group, the pKa values of the pigment can be estimated from the pKa values of the hydrophilic group introduced, though actual measurement is needed because the pKa values obtained are different from those of a single substance. Examples of the alkali metal, which is included in “M” in the hydrophilic group, include Li, Na, K, Rb, and Cs. Examples of the organic ammonium include methylammonium, dimethylammonium, trimethylammonium, ethylammonium, diethylammonium, triethylammonium, monohydroxymethyl(ethyl)amine, dihydroxymethyl(ethyl)amine, and trihydroxymethyl(ethyl)amine. The combination of hyrophilic groups of the latter is, for example, as follows. The pKa value of methane-sulfonic acid is −1.2, the pKa value of acetic acid is 4.76, the pKa value of benzenesulfonic acid is −2.5, and the pKa value of benzoic acid is 4.2. The combination of hydrophilic groups whose pKa values are different from each other by 2 or more, such as the combination of benzenesulfonic acid and benzoic acid, can be used. Based on the pKa values of these hydrophilic groups, hydrophilic groups introduced into the self-dispersion pigment are determined.

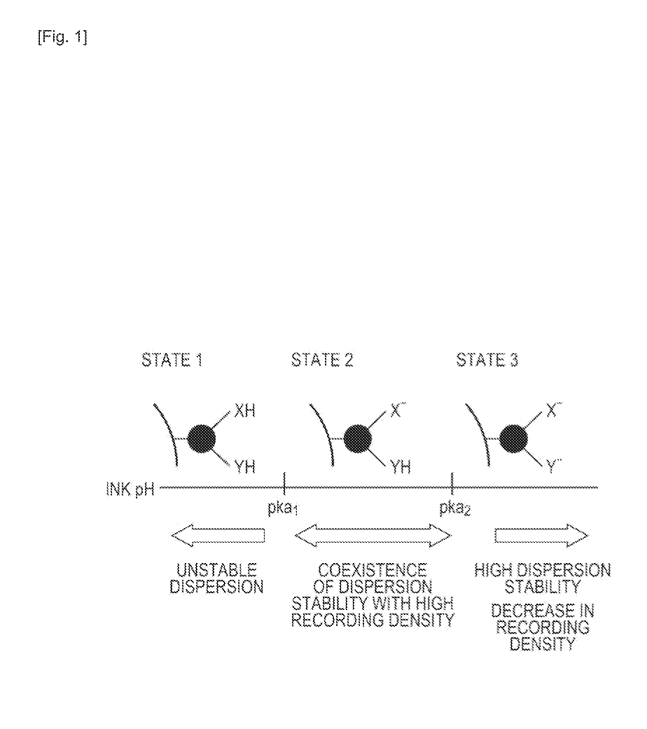

FIG. 1 shows the state of a hydrophilic group in the case where a self-dispersion pigment has one kind of hydrophilic group and the one kind of hydrophilic group has a plurality of pKa values. In FIG. 1, the dissociative group X in the hydrophilic group has pKa₁ and the dissociative group Y has pKa₂. It is believed that the hydrophilic group of the self-dispersion pigment in the ink is present in any one of the states 1 to 3 shown in FIG. 1 depending on the pH of the ink. If a pigment is in the state 1, that is, in the state in which both the dissociative groups X and Y are protonated, the pigment cannot be stably dispersed in the ink and thus is aggregated and precipitated.

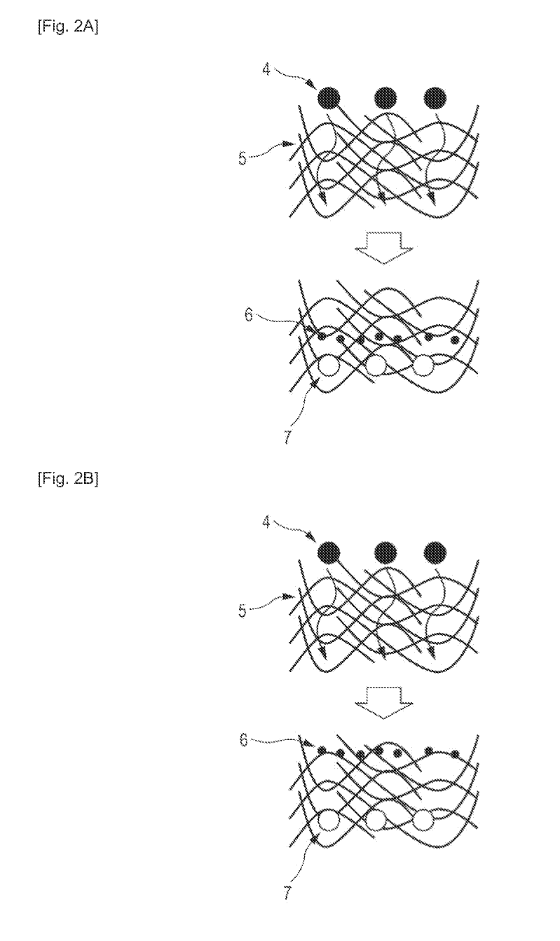

In contrast, if a pigment is in the state 3, that is, in the state in which both the dissociative groups X and Y are dissociated, the pigment can be stably dispersed. However, because the dispersion stability of a pigment is high, the aggregation and precipitation of the pigment does not easily occur immediately when an ink lands on a recording medium. Therefore, the pigment reaches the depths of plain paper through permeation and is fixed, which decreases the image density. FIG. 2A is a schematic view of this state. In particular when a super-permeability aqueous ink having a surface tension of 34 mN/m or less is used, since the permeation rate into plain paper is high, this phenomenon occurs more remarkably and the image density is significantly decreased. That is, in an aqueous ink 4 that has landed on cellulose fiber 5, solid-liquid separation into a pigment 6 and an ink 7 does not occur immediately and the pigment 6 permeates plain paper deeply and is fixed.

The state 2 in which only the dissociative group X is dissociated and the dissociative group Y is protonated has the following features. First, since the dissociative group X is dissociated, the pigment can be stably dispersed in the ink. Furthermore, since the dissociative group Y is protonated, solid-liquid separation occurs immediately after the ink lands on plain paper, the aggregation and precipitation of the pigment proceed, and the pigment is fixed in the outer layer of the plain paper. As a result, a recorded image having high image density can be obtained. FIG. 2B is a schematic view of this state. In an aqueous ink 4 that has landed on cellulose fiber 5, solid-liquid separation into a pigment 6 and an ink 7 occurs immediately and the pigment 6 is fixed in the outer layer of plain paper.

As described above, the inventors of the present invention have found that the co-existence of dispersion stability with high recording density is achieved by providing the self-dispersion pigments in the states 2 and 3 shown in FIG. 1 in a mixed manner with a certain ratio. Specifically, the pH value of the aqueous ink of the present invention is adjusted so that Mathematical formula (2) below is satisfied.

[Math.4]

pKa₂−1.5≦pH≦pKa₂+0.5 (2)

If the pH value of an aqueous ink is lower than a value of pKa₂−1.5, the pigment in the state 1 becomes dominant in the ink and the dispersion stability as an ink is decreased, which may cause aggregation and precipitation. If the pH value of an aqueous ink exceeds a value of pKa₂+0.5, the pigment in the state 3 shown in FIG. 1 becomes dominant in the ink and thus the image density tends to be decreased. To ensure dispersion stability when the pH value of the aqueous ink is adjusted to a value of pKa₂−1.5, the pH value of the aqueous ink needs to be sufficiently higher than pKa₁ Therefore, formula (1) needs to be satisfied. Moreover, to achieve both dispersion stability and high recording density, the aqueous ink is desirably neutral or acidic. Thus, the pKa₂ in the present invention needs to be 8.0 or less.

Other atomic groups may be interposed between the hydrophilic group and the pigment. Examples of the other atomic groups include straight-chain or branched-chain alkylene groups having 1 to 12 carbon atoms, substituted or unsubstituted phenylene groups, and substituted or unsubstituted naphthylene groups. An example of the substituent of the phenylene groups and the naphthylene groups is a straight-chain or branched-chain alkyl group having 1 to 6 carbon atoms.

The average particle size of the self-dispersion pigment of the present invention is preferably 60 nm or more, more preferably 70 nm or more, and further preferably 75 nm or more on the basis of the average particle size obtained by dynamic light scattering in liquid. The average particle size is also preferably 145 nm or less, more preferably 140 nm or less, and further preferably 130 nm or less. Specifically, the average particle size can be measured using FPAR-1000 (available from Otsuka Electronics Co., Ltd., cumulant method) or Nanotrac UPA-EX150 (available from NIKKISO Co., Ltd., integrated value of 50%) that utilizes scattering of laser beams.

The amount of the self-dispersion pigment added to the ink is preferably 0.5% or more, more preferably 1.0% or more, and further preferably 2.0% or more by mass relative to the total amount of the ink. The amount of the self-dispersion pigment is also preferably 15.0% or less, more preferably 10.0% or less, and further preferably 8.0% or less by mass.

The method in which the pH of an ink is adjusted is not particularly limited. When the ink is adjusted to be acidic, for example, an organic carboxylic acid such as acetic acid, propionic acid, phthalic acid, or benzoic acid; an organic sulfonic acid such as methanesulfonic acid, ethanesulfonic acid, or benzenesulfonic acid; an inorganic acid such as phosphoric acid, sulfuric acid, hydrochloric acid, or nitric acid; or a mixture thereof can be used. When the ink is adjusted to be alkaline, for example, a hydroxide of an alkali metal such as lithium, sodium, potassium, rubidium, or cesium; an organic ammonium such as ammonia, methylammonium, dimethylammonium, trimethylammonium, ethylammonium, diethylammonium, triethylammonium, monohydroxymethyl(ethyl)ammonium, dihydroxymethyl(ethyl)ammonium, trihydroxymethyl(ethyl)ammonium, or triethanolammonium; or a mixture thereof can be used.

The aqueous ink of the present invention can contain an organic acid or an inorganic acid having a pKa value equal to or lower than the pH of the aqueous ink, or a salt of the organic acid or the inorganic acid. This can increase the image density of a recorded image. The reason is considered to be as follows. For an ink containing an organic acid, an inorganic acid, or a salt thereof (hereinafter referred to as “organic acid or the like”), after the ink is supplied to plain paper, a self-dispersion pigment and the organic acid or the like act synergistically with each other, and solid-liquid separation is caused between the self-dispersion pigment and an aqueous medium. Consequently, a pigment is fixed in the outer layer of the plain paper and thus the image density is increased. Because the time taken from the landing of the ink to the plain paper to the fixing is shortened, blurs can be suppressed and the quality of small characters printed is improved. Furthermore, a size agent scattered on the surface of plain paper is effectively hidden, and there is observed an effect of preventing so-called “white patch” of a solid recorded portion. To produce the effect, the organic acid or the like needs to be dissociated in the aqueous ink. Therefore, the pKa value of the organic acid or the like added is desirably lower than the pH value of the aqueous ink. Examples of the organic acid include organic carboxylic acids such as citric acid, succinic acid, benzoic acid, acetic acid, propionic acid, phthalic acid, oxalic acid, tartaric acid, gluconic acid, tartronic acid, maleic acid, malonic acid, and adipic acid. Among them, acetic acid, phthalic acid, or benzoic acid is suitable. Examples of the inorganic acid include hydrochloric acid, sulfuric acid, and nitric acid. In the case where the organic acid or the like is present in a form of a salt, an alkali metal, ammonium, or an organic ammonium can be used as a counterion that serves to form a salt in the same manner as the case of a counterion of the self-dispersion pigment. Examples of the alkali metal serving as a counterion include Li, Na, K, Rb, and Cs. Examples of the organic ammonium include methylammonium, dimethylammonium, trimethylammonium, ethylammonium, diethylammonium, triethylammonium, mono-hydroxymethyl(ethyl)ammonium, dihydroxymethyl(ethyl)ammonium, trihydroxymethyl(ethyl)ammonium, and triethanolammonium. Among them, an ammonium is particularly suitable.

The amount of the organic acid or the like added to the ink is preferably 0.05% or more, more preferably 0.1% or more, and further preferably 0.2% or more by mass. The amount of the organic acid or the like is also preferably 3.0% or less, more preferably 2.0% or less, and further preferably 1.0% or less.

The aqueous ink of the present invention contains water. The content of water in the ink is desirably 30% or more and 95% or less by mass relative to the total mass of the ink.

The aqueous ink of the present invention can contain a water-soluble compound having a hydrophilic/hydrophobic coefficient of 0.26 or more that is defined by Formula (A) below. According to the types of paper, a water-soluble compound having a hydrophilic/hydrophobic coefficient of 0.26 or more and less than 0.37 and a water-soluble compound having a hydrophilic/hydrophobic coefficient of 0.37 or more are suitably used in combination. In some cases, an aqueous ink containing two or more water-soluble compounds each having a hydrophilic/hydrophobic coefficient of 0.37 or more is more suitable.

Hydrophilic/hydrophobic coefficient=[(water activity value of 20% aqueous solution)−(mole fraction of 20% aqueous solution)}/{1−(mole fraction of 20% aqueous solution)} Formula (A)

The water activity value in the formula is represented by the formula below.

Water activity value=(vapor pressure of aqueous solution)/(vapor pressure of pure water)

The water activity value can be measured by various methods, and the measurement method is not limited to a specific one. A material used in the present invention is suitably measured through chilled mirror dew point measurement. The values mentioned in this specification are obtained by measuring 20% aqueous solutions of water-soluble compounds at 25 degrees (Celsius) with AquaLab CX-3TE (available from Decagon Devices, Inc.) that uses the above-described method. In accordance with Raoult's law, the depression rate of vapor pressure of a dilute solution is equal to the mole fraction of a solute, regardless of the types of solvent and solute used. Therefore, the mole fraction of water in the aqueous solution is made to be equal to the water activity value. However, the water activity value obtained by measuring the aqueous solutions of various water-soluble compounds often does not match the mole fraction of water. When the water activity value of an aqueous solution is lower than the mole fraction of water, the vapor pressure of the aqueous solution is lower than the theoretical calculated value and the vaporization of water is suppressed due to the presence of a solute. Thus, it is understood that the solute is a substance having a strong hydration force. In contrast, when the water activity value of an aqueous solution is higher than the mole fraction of water, it is understood that the solute is a substance having a weak hydration force.

The inventors of the present invention have focused on the point that the degree of hydrophilicity or hydrophobicity of a water-soluble compound contained in an ink significantly affects the promotion of solid-liquid separation between a self-dispersion pigment and an aqueous medium and various ink properties. Thus, the inventors have defined the hydrophilic/hydrophobic coefficient represented by Formula (A). The water activity value is obtained by measuring the aqueous solutions of various water-soluble compounds at the same concentration of 20% by mass. By converting the water activity value using Formula (A), the degrees of hydrophilicity or hydrophobicity of various solutes can be relatively compared with each other even if the mole fractions of water are different from each other due to the difference in the molecular weight of solutes. Herein, since the water activity value of an aqueous solution never exceeds 1, the maximum value of the hydrophilic/hydrophobic coefficient is 1. Table 1 shows the hydrophilic/hydrophobic coefficients, of water-soluble compounds, that are obtained from Formula (A). Note that the water-soluble compound of the present invention is not limited thereto.

TABLE 1

| | Hydrophilic/ |
|---|---|
| | hydrophobic |
| Name of substance | coefficient |
| 1,2-hexanediol | 0.97 |
| 1,2-pentanediol | 0.93 |
| 3-methyl-1,3-butanediol | 0.90 |
| 1,2-butanediol | 0.90 |
| 2,4-pentanediol | 0.88 |
| 1,6-hexanediol | 0.76 |
| 1,7-heptanediol | 0.73 |
| 3-methyl-1,5-pentanediol | 0.54 |
| 1,5-pentanediol | 0.41 |
| trimethylolpropane | 0.31 |
| ethylene urea | 0.30 |
| 1,2,6-hexanetriol | 0.28 |
| 1,2,3-butanetriol | 0.22 |
| sorbitol | 0.21 |
| urea | 0.20 |
| diethylene glycol | 0.15 |
| 1,2,4-butanetriol | 0.15 |
| glycerin | 0.11 |
| diglycerin | 0.08 |
| triethylene glycol | 0.07 |
| polyethylene glycol 200 | −0.09 |
| polyethylene glycol 600 | −0.43 |

The inventors have obtained the following findings by examining the relationship between water-soluble compounds and various ink properties in the case where water-soluble compounds having different hydrophilic/hydrophobic coefficients are contained in the ink. In the case of an ink containing the self-dispersion pigment of the present invention, the printing properties concerning small characters such as bleeding between two colors and character thickening were improved when a water-soluble compound having a hydrophilic/hydrophobic coefficient of 0.26 or more, which is more hydrophobic, was used. In particular, a water-soluble compound having a glycol structure in which the number of carbon atoms that are not substituted with a hydrophilic group is larger than the number of carbon atoms that are substituted with a hydrophilic group in a glycol structure was suitable. This may be because, after an ink lands on paper, such a water-soluble compound strongly promotes the solid-liquid separation of the self-dispersion pigment due to a relatively weak affinity for water, a self-dispersion pigment, and a cellulose fiber. In particular, trimethylolpropane is suitable as a water-soluble compound having a hydrophilic/hydrophobic coefficient of 0.26 or more and less than 0.37, which is defined by Formula (A). Furthermore, a water-soluble compound having a glycol structure of hydrocarbon with 4 to 7 carbon atoms is suitable as a water-soluble compound having a hydrophilic/hydrophobic co-efficient of 0.37 or more. In particular, 1,2-hexanediol or 1,6-hexanediol is suitable. When two or more water-soluble compounds each having a hydrophilic/hydrophobic coefficient of 0.37 or more are used, the difference in hydrophilic/hydrophobic co-efficient is desirably 0.1 or more.

The content of the water-soluble compounds in the ink is preferably 5.0% or more, more preferably 6.0% or more, and further preferably 7.0% or more by mass in total. The content of the water-soluble compounds is also preferably 40.0% or less, more preferably 35.0% or less, and further preferably 30.0% or less by mass.

To achieve well-balanced ejection stability, the aqueous ink of the present invention can contain a surfactant in the ink. In particular, a nonionic surfactant is suitably contained. Specifically, a polyoxyethylene alkyl ether or an ethylene oxide adduct of acetylene glycol is particularly suitable. The hydrophile-lipophile balance (HLB) of such nonionic surfactants is 10 or more. The content of the surfactant added together in the ink is preferably 0.1% or more, more preferably 0.2% or more, and further preferably 0.3% or more by mass. The content of the surfactant is also preferably 5.0% or less, more preferably 4.0% or less, and further preferably 3.0% or less by mass.

To provide an ink having desired physical properties, the aqueous ink of the present invention may optionally contain a viscosity modifier, an antifoaming agent, an antiseptic, a fungicide, an antioxidant, and a penetrant as an additive, in addition to the components described above.

The surface tension of the ink used in the present invention is 34 mN/m or less. The surface tension of the ink is preferably 33 mN/m or less and more preferably 32 mN/m or less. The surface tension is also preferably 27 mN/m or more, more preferably 28 mN/m or more, and further preferably 29 mN/m or more. By controlling the surface tension of the ink in the range, high ink absorbency can be achieved and the advantages of the aqueous ink of the present invention are maximized.

Unlike plain paper, glossy paper or matte paper, which is inkjet paper, includes a porous ink-absorbing layer formed on the surface of paper. Therefore, the permeation of an ink proceeds quickly with little effect of the surface tension of the ink. However, since a size agent having a water-repellent effect is internally and/or externally added to plain paper, the permeation of an ink to plain paper is often inhibited. In other words, the critical surface tension of plain paper, which is an indicator that indicates how quickly the surface is wetted with an ink, is lower than that of inkjet paper. When the surface tension of an ink is higher than 34 mN/m, the surface tension is higher than the critical surface tension of plain paper. Therefore, even if an ink lands on paper, the ink is not wetted immediately and the ink does not start to permeate the plain paper immediately. When the surface tension of an ink is high, the ink is not easily fixed quickly even if the contact angle between an ink and paper is decreased by improving wettability to paper to some degree. Furthermore, the ink fixing property tends to be degraded. When the surface tension of an ink is 34 mN/m or less, pore absorption mainly proceeds. When the surface tension is higher than 34 mN/m, fiber absorption mainly proceeds. For the two types of absorption of an ink into paper, the absorption rate of the pore absorption is much higher than that of the fiber absorption. In the present invention, high-speed fixation is achieved by employing an ink that undergoes pore absorption. The ink that undergoes pore absorption is also advantageous in that bleeding caused when two different color inks are recorded so as to be adjacent to each other is suppressed. This is because two types of inks are prevented from simultaneously remaining on the surface of paper. In addition, such an ink is advantageous in that high image density is achieved.

### Image-Forming Method

An image-forming method of the present invention is an inkjet image-forming method in which an ink is supplied by an inkjet technique in a constant amount of 0.5 pl or more and 6.0 pl or less at a time. The amount is preferably 1.0 p1 or more and more preferably 1.5 p1 or more. The amount is also preferably 5.0 pl or less and more preferably 4.5 pl or less. If the amount is less than 0.5 p1, the fixing property and water resistance of an image may be degraded, which is unsuitable. If the amount is more than 6.0 pl, character thickening may be caused when small characters with a size of about 2 point to 5 point (1 point is nearly equal to 0.35 mm) and thus the characters are blurred.

Since the ejection volume of an ink significantly affects the strike through of the ink, the ejection volume is important in the application for duplex printing. In plain paper, pores with a size of 1 to 100 micrometers, mainly 0.5 to 5.0 micrometers, are distributed. In the present invention, plain paper means bond paper and copier paper such as high-quality paper, medium-quality paper, and plain paper copier (PPC) paper that are commercially available and used in printers and copiers in large quantity. The permeation phenomena of an aqueous ink into plain paper are broadly divided into fiber absorption in which an ink is directly absorbed into cellulose fiber itself of plain paper and pore absorption in which an ink is absorbed into the pores formed between cellulose fibers. For an ink used in the present invention, pore absorption mainly proceeds. Therefore, if the ink used in the present invention is supplied to plain paper and part of the ink is brought into contact with relatively large pores having a size of about 10 micrometers or more that are present on the surface of plain paper, the ink is absorbed into such relatively large pores in a concentrated manner in accordance with Lucas-Washburn Equation and the permeation proceeds. As a result, since that portion is permeated by an ink particularly deeply, it is quite disadvantageous in terms of achieving high color development in plain paper. On the other hand, the contact probability of a droplet of ink into such relatively large pores is decreased as the size of an ink is decreased. Therefore, an ink is not easily absorbed into relatively large pores in a concentrated manner. Furthermore, even if the ink is brought into contact with relatively large pores, only a small amount of ink permeates the paper deeply if the size of an ink is small. Consequently, the image obtained on plain paper has high color development.

In the present invention, a constant amount of ink means an ink that is ejected while the structures of nozzles constituting a recording head are not differentiated from one another so that the driving energy provided is not changed. In other words, in such a state, the amount of ink supplied is constant even if there is a slight variation in ejection caused by manufacturing errors of apparatuses. By supplying a constant amount of ink, the permeation depth of an ink is stabilized. This achieves high image density of a recorded image and satisfactory uniformity of an image. However, for example, in a system used by changing the amount of ink supplied, the amount of ink supplied is not constant and there are ink droplets having different volumes in a mixed manner. Therefore, the variation in the permeation depth of ink is increased. Particularly in the high-duty area of a recorded image, there are some regions with low image density due to the variation in permeation depth, for example. Consequently, the uniformity of an image is degraded.

To supply a constant amount of ink, a thermal inkjet method in which an ink is supplied through action of thermal energy is suitable in terms of the mechanism of ejection. That is, the thermal inkjet method suppresses the variation in the permeation depth of an ink and provides a recorded image with high density and satisfactory uniformity. Furthermore, the thermal inkjet method is suitable for using multiple noises and achieving high density compared with a method in which an ink is supplied using a piezoelectric element, and is also suitable for high-speed recording.

The area where duty is calculated is 50 micrometers * 50 micrometers. An image having an area with a duty of 80% or more means an image having an area where an ink is supplied to 80% or more of lattices in a matrix of the area in which duty is calculated. The size of the lattices is determined in accordance with the resolution of a basic matrix. For example, when the resolution of a basic matrix is 1200 dpi * 1200 dpi, the size of a single lattice is 1/1200 inches * 1/1200 inches.

An image having an area with a duty of 80% or more in a basic matrix means an image having an area with a duty of 80% or more in a basic matrix with a single-color ink. That is, in the case where four-color inks, namely black, cyan, magenta, and yellow, are used, such an image means an image having an area with a duty of 80% or more in a basic matrix with at least one of the four-color inks. On the other hand, in an image that does not have an area with a duty of 80% or more in a basic matrix, the overlapping region of inks that have landed is relatively small. In this case, problems such as blurs of characters and bleeding often do not occur even if printing processes are not improved.

A basic matrix of the present invention can be freely set in accordance with a recording apparatus or the like. The resolution of a basic matrix is preferably 600 dpi or more and more preferably 1200 dpi or more. The resolution is also preferably 4800 dpi or less. The length and width may be the same or different from each other as long as the resolution is within the range.

With the aqueous ink of the present invention, a recorded image with high density can be obtained even if single-pass printing in which an ink is not supplied in a divided manner is performed. However, if an image is formed by a divided ink supply method in which an ink is supplied in a divided manner, the characteristics of the aqueous ink and the recording method act synergistically with each other, which can provide a recorded image with higher density. In this case, when an image having an area with a duty of 80% or more and a total ink-supply amount of 5.0 microliters per square centimeter or less is formed in a basic matrix where the image is to be formed, supply of the ink can be performed two or more times in a divided manner. The amount of the ink per supply is 0.7 microliters per square centimeter or less, preferably 0.6 microliters per square centimeter or less, and more preferably 0.5 microliters per square centimeter or less. By employing such a recording method, high image density can be achieved, and strike through, blurs of characters, and bleeding can be suppressed.

In the present invention, when supply of a single-color ink is performed two or more times in a divided manner, the interval between the beginning and the end of ink supply to a basic matrix is desirably 1 ms or more and 200 ms or less. By performing printing under the condition, color developability and the quality of small characters are significantly improved. This means that, when printing is performed a plurality of times in a divided manner, a certain interval is desirably ensured between the supply of the first ink to a basic matrix and the supply of the last ink. The reason is considered to be as follows. If the last ink droplet lands on plain paper before the first ink droplet is sufficiently fixed into the plain paper, the droplets are combined with each other to form a large droplet (beading). The large droplet permeates the plain paper deeply through relatively large pores on the plain paper, which decreases color developability. Furthermore, the large droplet spreads in a horizontal direction that is the direction of fiber in the plain paper. As a result, the sharpness of characters is lost. In the present invention, supply of an ink is performed a plurality of times in a divided manner and the interval between the beginning and the end of single-color-ink supply to a basic matrix is set to 1 ms or more and 200 ms or less. Therefore, there is a sufficient interval between the landing of an ink droplet on a recording medium and the solid-liquid separation of the ink droplet. Consequently, image density and the quality of characters are considered to be improved.

When supply of a single-color ink is performed three or more times in a divided manner, the interval between supply of ink and the next supply is suitably 1 ms or more. By performing recording under the condition, the decrease in image density and the degradation of the quality of characters caused by the combination of ink droplets are reduced. Even if the time taken from the beginning to the end of single-color-ink supply to a basic matrix is set to more than 200 ms, the color developability is not effectively improved. Therefore, in the present invention, the upper limit of the time is set to 200 ms to achieve high-speed printing. The lower limit of the time taken from the beginning to the end of single-color-ink supply to a basic matrix is set to 1 ms, but the time is preferably 3 ms or more, more preferably 6 ms or more, and further preferably 10 ms or more. By setting the time taken from the beginning to the end of single-color-ink supply to a basic matrix in such a manner, the advantages of the ink used in the present invention can be maximized. In other words, an image with high image density and high quality can be obtained and high-speed inkjet recording is achieved.

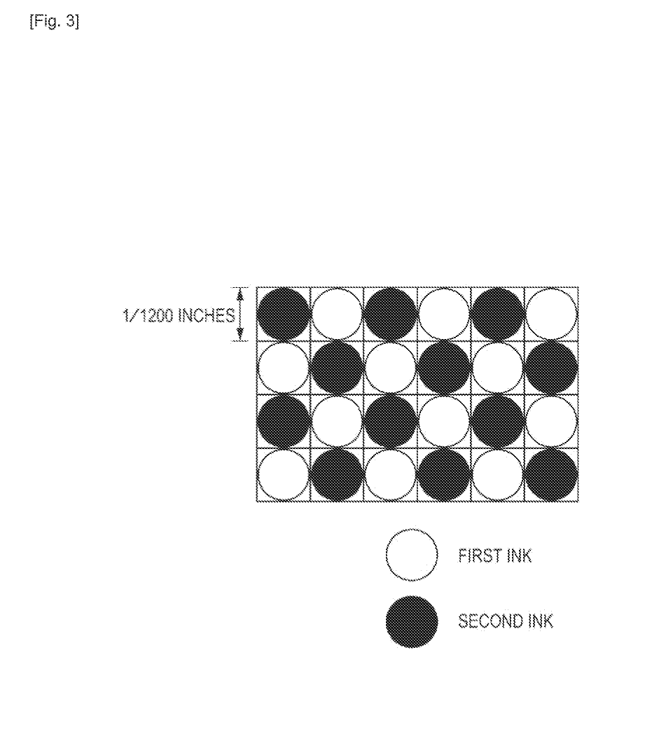

The methods for performing supply of an ink two or more times in a divided manner are broadly classified into a serial type method and a line type method. As an example of the serial type method, when solid printing is completed by performing supply of an ink twice in a divided manner, a recording head passes over a recording medium twice (two passes). In most cases of the divided ink supply, an equal amount of ink is supplied every time, but the present invention is not limited thereto. FIG. 3 shows an arrangement example of the landing positions of dots in the two-pass printing when the amount of ink that is equivalent to 50% of the total is supplied to a recording medium at the first pass and the remaining amount of ink that is equivalent to 50% of the total is supplied to the remaining portions of the recording medium at the second pass so that 100% solid printing is performed. In FIG. 3, the first inks and the second inks have a constant amount.

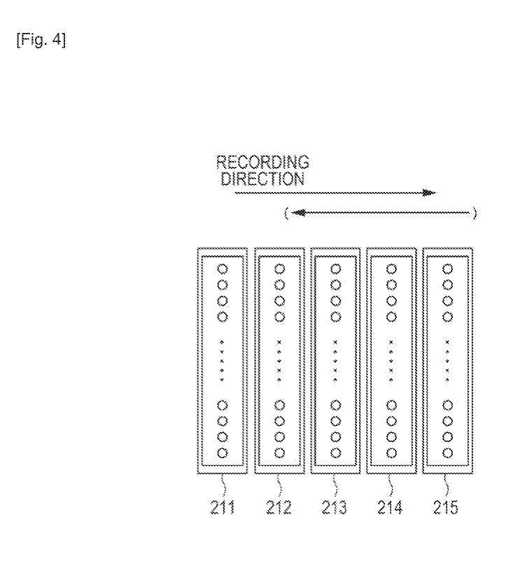

In addition to the serial type divided ink supply method described above, the present invention supports the line type method in which a recording head passes over a recording medium once (one pass) and dots are printed to the same positions as those shown in FIG. 3 by performing supply of an ink twice in a divided manner. For example, the recording head shown in FIG. 4 is exemplified as a configuration in which a black ink is supplied in the one-pass printing while the supply of the ink is performed twice in a divided manner. In the configuration of recording heads for color printing, recording heads 211, 212, 213, 214, and 215 are respectively configured to eject a black (K) ink, a cyan (C) ink, a magenta (M) ink, a yellow (Y) ink, and a black (K) ink. This example shows the configuration of a head when a black ink is supplied from two separate nozzle rows so as to be supplied substantially in the one-pass printing. Similarly, by changing the number of nozzle rows of a head and the number of inks provided, various inks can be supplied to a recording medium by a method in which the printing is performed two or more times in a divided manner while a recording head passes over the recording medium once (one pass). That is to say, an ink can be supplied two or more times in a divided manner, within the same period of time as that required for a single-pass method in which an ink is not supplied in a divided manner. Inkjet recording apparatus

An inkjet recording apparatus that is suitable for the present invention will now be described. The apparatus that is suitable for the present invention includes a recording head that supplies an ink with a constant amount of 0.5 pl or more and 6 pl or less by an inkjet method. The recording head of the inkjet recording apparatus of the present invention is desirably a recording head that supplies an ink by applying thermal energy to the ink. Such a recording head is more suitable for achieving high-density nozzles than a recording head that supplies an ink using a piezoelectric element. Furthermore, since such a recording head is excellent in terms of achieving ink supply in a constant amount, the variation in the permeation depth of an ink is suppressed and satisfactory uniformity of a recorded image is achieved.

For the typical configurations and principles of the recording head that supplies an ink by applying thermal energy to the ink, the basic principles disclosed, for example, in PTL 2 and PTL 3 can be used. This method can be applied to either an on-demand type or a continuous type, and the on-demand type is more advantageous than the continuous type. In the case of the on-demand type, at least one driving signal that corresponds to recording information and causes a rapid temperature increase, which is beyond nuclear boiling, is applied to electric thermal conversion members disposed so as to correspond to sheets or channels that hold an ink. Consequently, thermal energy is generated in the electric thermal conversion members and film boiling is caused on the heated surface of a recording head, whereby bubbles that each have a one-to-one correspondence with the driving signal can be formed in an ink. An ink is ejected through an ejection orifice due to the growth and shrinkage of the bubbles to form at least a single droplet. If pulse signaling is used for the driving signal, the growth and shrinkage of the bubbles are immediately and appropriately performed. Thus, a constant amount of ink can be ejected and also ink ejection with excellent responsiveness can be achieved.

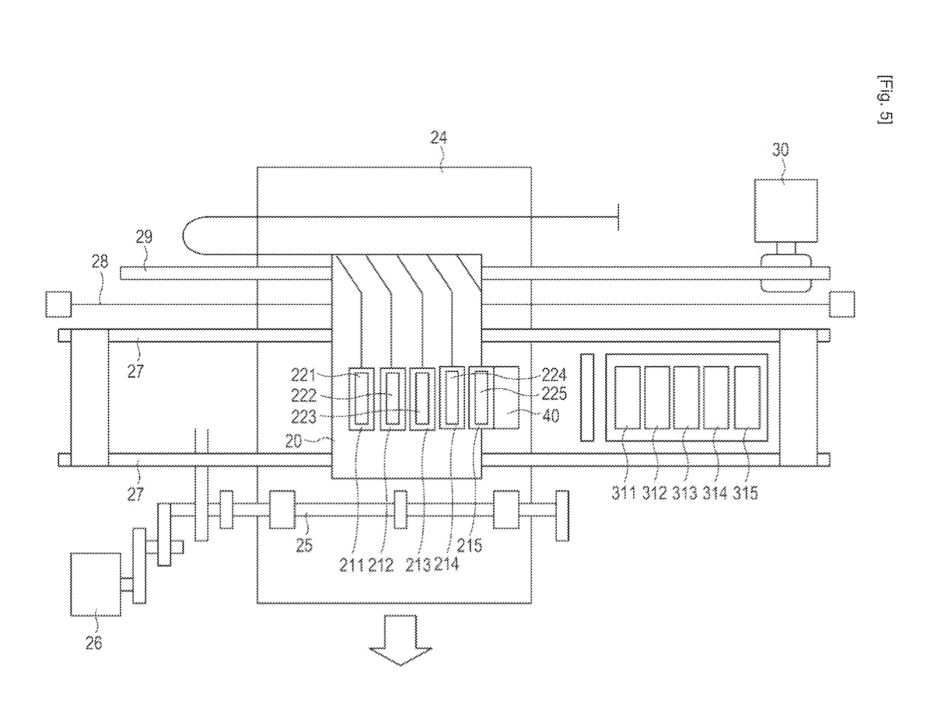

FIG. 5 is a front view schematically showing an embodiment of an inkjet recording apparatus according to the present invention. A carriage 20 includes a plurality of recording heads 211 to 215 that use an inkjet method. A plurality of ink ejection orifices configured to eject an ink are arranged in each of the recording heads 211 to 215. In a configuration in which a black ink is supplied twice in a divided manner in the one-pass printing, the recording heads 211, 212, 213, 214, and 215 are recording heads of the present invention that are configured to eject a black (K) ink, a cyan (C) ink, a magenta (M) ink, a yellow (Y) ink, and a black (K) ink, respectively. Ink cartridges 221 to 225 are respectively constituted by recording heads 211 to 215 and ink tanks configured to supply inks to the recording heads 211 to 215. A reflection-type density sensor 40 is disposed on the side face of the cartridge 20 and can detect the density of a test pattern recorded on a recording medium. Control signals or the like are transmitted to the recording heads 211 to 215 through a flexible cable 23. A recording medium 24 with exposed cellulose fiber, such as plain paper, is conveyed through conveying rollers (not shown), sandwiched between discharge rollers 25, and then conveyed in the direction (sub-scanning direction) indicated by an arrow with the driving of a convey motor 26. A guide shaft 27 and a linear encoder 28 are configured to guide and support the carriage 20. The carriage 20 reciprocates along the guide shaft 27 in a main-scanning direction through a driving belt 29 driven by a carriage motor 30. Heating elements (electric thermal conversion members) configured to generate thermal energy for ink ejection are disposed inside the ink ejection orifices (channels) of the recording heads 211 to 215. The heating elements are driven in accordance with recording signals, and ink droplets are ejected and attached to a recording medium in synchronization with the readout timing of the linear encoder 28, whereby an image is formed. A recovery unit 32 including caps 311 to 315 is disposed at the home position of the carriage 20, the home position being outside the recording region. When recording is not performed, the carriage 20 is moved to the home position, and the ink ejection surfaces of the recording heads 211 to 215 are sealed with the respective caps 311 to 315. Thus, clogging caused by the adhesion of ink due to the vaporization of an ink solvent or the sticking of foreign substances such as dust can be prevented. The capping function of the caps is used to solve the ejection failure and clogging of ink ejection orifices that are less frequently used. Specifically, the caps are used to perform idle ejection for preventing ejection failure. In the idle ejection, an ink is ejected to the caps that are apart from the ink ejection orifices. Furthermore, the caps are used to perform ejection recovery of the ejection orifices having ejection failure by sucking an ink from the ink ejection orifices using a pump (not shown) while the ink ejection orifices are sealed with the caps. An ink receiving unit 33 receives ink droplets that are preliminarily ejected just before the recording operation when the recording heads 211 to 215 pass over the ink receiving unit 33. By disposing a blade and a wiping unit (not shown) at a position next to the caps, ink-ejection-orifice surfaces of the recording heads 211 to 215 can be cleaned. As described above, it is desirable that a recovery unit and a preliminary unit for recording heads are added to the configuration of the recording apparatus. Consequently, the recording operation is further stabilized. Examples of such units include a capping unit for recording heads, a cleaning unit, a pressurizing or sucking unit, and an electric thermal conversion member, a heating element different from the electric thermal conversion member, or a preliminary heating unit obtained by combining the electric thermal conversion member with the heating element. To stably perform recording, it is also effective to include a pre-liminary ejection mode that performs ejection separately from recording.

In addition, a cartridge type recording head may be used. In the cartridge type recording head, an ink tank is integrally disposed on the recording head itself described above. A chip type exchangeable recording head may also be used. In the chip type recording head, a recording head is mounted on the main body of the apparatus, whereby the recording head can be electrically connected to the main body and an ink can be supplied from the main body.

FIG. 4 shows the recording heads 211 to 215. In FIG. 4, the scanning direction of recording of the recording heads 211 to 215 is a direction indicated by an arrow. Each of the recording heads 211 to 215 includes a plurality of ejection orifices of nozzles arranged in a direction substantially perpendicular to the scanning direction of recording. The recording heads eject ink droplets from the ejection orifices at a certain timing while performing scanning in the scanning direction of recording shown in the drawing. Thus, an image is formed on a recording medium at a resolution corresponding to the density of nozzle rows. Herein, the recording head may perform a recording operation in one of the scanning directions. The recording head may also perform a recording operation during either outgoing or returning movement of the reciprocation.

In the above-described embodiment, a serial type recording apparatus that performs recording while a recording head performs scanning has been described. However, a full-line type recording apparatus that uses a recording head having a length corresponding to the width of a recording medium may be used. The full-line type recording head can be obtained by arranging the serial type recording heads in a staggered manner or in parallel to increase the length and thus achieve a desired length. Alternatively, an integrally formed single recording head having long nozzle rows may be used.

The above-described serial type or line type recording apparatus is an example of a recording apparatus having an independently or integrally-formed head constituted by five ejection orifice rows (nozzle rows) that include two black ink nozzle rows (recording heads 211 and 215). In the.recording apparatus, only a black ink among four-color inks (Y, M, C, and K) is supplied twice in a divided manner. When supply of an ink is performed about two to twelve times in a divided manner using four ejection orifice rows (nozzle rows), for at least one of the four-color inks (Y, M, C, and K), a single-color ink can be provided to a plurality of ejection orifice rows (nozzle rows). For example, two or three heads each constituted by four ejection orifice rows (nozzle rows) are connected to one another to obtain eight ejection orifice rows (nozzle rows) or twelve ejection orifice rows (nozzle rows).

In the inkjet recording apparatus of the present invention, when an image having an area with a duty of 80% or more and a total ink-supply amount of 5.0 microliters per square centimeter or less is formed in a basic matrix where the image is to be formed, supply of the ink is performed two or more times in a divided manner. The amount of ink supplied per time is 0.7 microliters per square centimeter or less. The inkjet recording apparatus of the present invention includes a control mechanism for performing such a divided ink supply. The control mechanism performs such a divided ink supply by controlling the operation of an inkjet recording head and the timing of feed of plain paper.

### EXAMPLES

The present invention will now be described with Examples, but is not limited to

Examples. In the description below, “part” or “%” is on a mass basis unless otherwise specified. The surface tension of an aqueous ink was measured with CBVP-Z (available from Kyowa Interface Science Co., Ltd.). The average particle size of a self-dispersion pigment was measured with Nanotrac UPA-150EX (available from NIKKISO Co., Ltd.).

In Examples, a self-dispersion pigment A produced by the method below and a self-dispersion pigment B contained in a commercially available self-dispersion pigment dispersion solution (trade name: CAB-O-JET400 available from Cabot Corporation) were used.

### Production of Self-Dispersion Pigment A

After 100 g of carbon black having a specific surface area of 220 square meters per gram and a DBP oil absorption of 105 ml/100 g and 45.1 g of 4-aminophthalic acid were mixed in 720 g of water thoroughly, 16.2 g of nitric acid was added dropwise to the mixture and stirring was performed at 70 degrees (Celsius). After 10 minutes, a solution obtained by dissolving 10.7 g of sodium nitrite in 50 g of water was added to the mixture, and the mixture was further stirred for one hour. The resultant slurry was filtered using filter paper (trade name: Toyo filter paper No. 2 available from Advantis Co.). The obtained pigment particles were thoroughly cleaned with water and dried in an oven at 90 degrees (Celsius). Through the processes described above, a pigment A was obtained. Subsequently, the pigment A was added to ion-exchange water so that the concentration was adjusted to 10%. The pH of the solution was adjusted to 7.5 with an aqueous ammonia solution. The solution was filtered using a prefilter and a 1-micrometer filter to obtain a self-dispersion pigment dispersion solution containing a self-dispersion pigment A in which a hydrophilic group represented by Chemical formula (1) is introduced on the surface of carbon black.

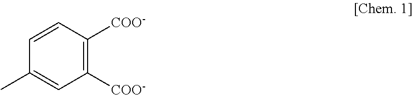

The self-dispersion pigment dispersion solution containing the self-dispersion pigment A and CAB-O-JET400 containing the self-dispersion pigment B were each subjected to neutralization titration using 798MPT Titrino (available from Metrohm) to measure pKa. Specifically, potassium hydroxide was added to the self-dispersion pigment dispersion solution containing the self-dispersion pigment A and CAB-O-JET400 so that the pH thereof was adjusted to 10, and then neutralization titration was performed using 0.1 M hydrochloric acid. Consequently, the self-dispersion pigment A had acid dissociation constants (pKa) at a pH of 2.9 (pKa₁) and 5.9 (pKa₂). The self-dispersion pigment B had acid dissociation constants (pKa) at a pH of 2.5 (pKa₁) and 6.1 (pKa₂).

A method for preparing aqueous inks of Examples and Comparative Examples of the present invention will now be described. Ion-exchange water was used as water.

### Preparation of Aqueous Ink 1

An aqueous ink 1 was obtained by mixing all the components described below (100 parts in total), stirring the mixture for two hours, and filtering the mixture with a 2.5-micrometer filter. The surface tension was 30.0 mN/m and the average particle size of the self-dispersion pigment was 120 nm. The pH of the ink was adjusted to 5.6 with acetic acid.

self-dispersion pigment B: 5 parts

trimethylolpropane (hydrophilic/hydrophobic coefficient 0.31): 15 parts

1,2-hexanediol (hydrophilic/hydrophobic coefficient 0.97): 5 parts

isopropyl alcohol: 1 part

ethylene oxide adduct of acetylene glycol (trade name: Olfine E1010 available from Nisshin Chemical Industry Co., Ltd., HLB: 10 or more): 1 part

water: the balance

### Preparation of Aqueous Ink 2

An aqueous ink 2 was obtained through the same processes as those of the aqueous ink 1, except that the pH of the ink was adjusted to 6.6 with acetic acid. The surface tension was 30.0 mN/m and the average particle size of the self-dispersion pigment was 120 nm.

### Preparation of Aqueous ink 3

An aqueous ink 3 was obtained through the same processes as those of the aqueous ink 1, except that the pH of the ink was adjusted to 5.6 with hydrochloric acid. The surface tension was 30.0 mN/m and the average particle size of the self-dispersion pigment was 120 nm.

### Preparation of Aqueous Ink 4

An aqueous ink 4 was obtained by mixing all the components described below (100 parts in total), stirring the mixture for two hours, and filtering the mixture with a 2.5-micrometer filter. The surface tension was 30.0 mN/m and the average particle size of the self-dispersion pigment was 120 nm. The pH of the ink was adjusted to 5.6 with hydrochloric acid.

self-dispersion pigment B: 5 parts

ammonium benzoate: 0.7 parts

trimethylolpropane (hydrophilic/hydrophobic coefficient 0.31): 15 parts

1,2-hexanediol (hydrophilic/hydrophobic coefficient 0.97): 5 parts

isopropyl alcohol: 1 part

ethylene oxide adduct of acetylene glycol (trade name: Olfine E1010 available from Nisshin Chemical Industry Co., Ltd., HLB: 10 or more): 1 part

water: the balance

### Preparation of Aqueous Ink 5

An aqueous ink 5 was obtained by mixing all the components described below (100 parts in total), stirring the mixture for two hours, and filtering the mixture with a 2.5-micrometer filter. The surface tension was 30.0 mN/m and the average particle size of the self-dispersion pigment was 120 nm. The pH of the ink was adjusted to 5.6 with hydrochloric acid.

self-dispersion pigment B: 5 parts

sodium sulfate: 0.36 parts

trimethylolpropane (hydrophilic/hydrophobic coefficient 0.31): 15 parts

1,2-hexanediol (hydrophilic/hydrophobic coefficient 0.97): 5 parts

isopropyl alcohol: 1 part

ethylene oxide adduct of acetylene glycol (trade name: Olfine E1010 available from Nisshin Chemical Industry Co., Ltd., HLB: 10 or more): 1 part

water: the balance

### Preparation of Aqueous ink 6

An aqueous ink 6 was obtained through the same processes as those of the aqueous ink 1, except that a pH-adjusting agent was not added. The pH of the ink was 8.2, the surface tension was 30.0 mN/m, and the average particle size of the self-dispersion pigment was 120 nm.

### Preparation of Aqueous Ink 7

An aqueous ink 7 was obtained through the same processes as those of the aqueous ink 1, except that the pH of the ink was adjusted to 4.5 with acetic acid. The surface tension was 30.0 mN/m and the average particle size of the self-dispersion pigment was 120 nm.

### Preparation of Aqueous Ink 8

An aqueous ink 8 was obtained by mixing all the components described below (100 parts in total), stirring the mixture for two hours, and filtering the mixture with a 2.5-micrometer filter. The surface tension was 30.0 mN/m and the average particle size of the self-dispersion pigment was 120 nm. The pH of the ink was adjusted to 5.6 with hydrochloric acid.

self-dispersion pigment A: 5 parts

ammonium benzoate: 0.7 parts

trimethylolpropane (hydrophilic/hydrophobic coefficient 0.31): 15 parts

1,2-hexanediol (hydrophilic/hydrophobic coefficient 0.97): 5 parts

isopropyl alcohol: 1 part

ethylene oxide adduct of acetylene glycol (trade name: Olfine E1010 available from Nisshin Chemical Industry Co., Ltd., HLB: 10 or more): 1 part

water: the balance

### Preparation of Aqueous Ink 9

An aqueous ink 9 was obtained through the same processes as those of the aqueous ink 8, except that a pH-adjusting agent was not added. The pH of the ink was 7.0, the surface tension was 30.0 mN/m, and the average particle size of the self-dispersion pigment was 120 nm.

### Preparation of Aqueous ink 10

An aqueous ink 10 was obtained through the same processes as those of the aqueous ink 8, except that the pH of the ink was adjusted to 4.0 with hydrochloric acid. The surface tension was 30.0 mN/m and the average particle size of the self-dispersion pigment was 120 nm.

### Evaluation: Examples 1 to 6 and Comparative Examples 1 to 4

The following evaluations were performed in terms of dispersion stability and image density.

### Dispersion Stability

The aqueous inks 1 to 10 were evaluated in terms of dispersion stability under the conditions below. Each of the aqueous inks was stirred and then left to stand. After 30 minutes, the state of the ink was determined through visual inspection in accordance with the following criteria.

A: The aggregation and precipitation of pigment was not observed.

B: The aggregation and precipitation of pigment was observed.

### Image Density

Recorded images were formed using the aqueous inks 1 to 6, 8, and 9 under the conditions below.

inkjet recording apparatus: F930 available from CANON KABUSHIKI KAISHA (the recording head includes six ejection orifice rows, each of which has 512 nozzles; the amount of ink is 4.0 pl (constant amount); and the maximum resolution is 1200 dpi (width) * 1200 dpi (length))

recording medium: PPC paper SW-101 (available from CANON KABUSHIKI KAISHA) and PPC paper Xerox 4200 (available from Xerox Corporation)

image-forming method (single ink supply): each of the inks was provided to a black ink head unit of a printer, and a solid image was printed without performing divided ink supply. The amount of ink per supply was 1.0 microliters per square centimeter.

image-forming method (divided ink supply): when printing was performed twice in a divided manner, each of the inks was provided to a black ink head unit and a cyan ink head unit of a printer, and a solid image was printed, unless otherwise specified. The time interval between the ink ejection from the black ink head unit and the ink ejection from the cyan ink head unit was 12 ms. The amount of ink per supply (the amount of ink ejected from each of the head units) was 0.5 microliters per square centimeter for each of the inks. That is, the total amount of the two inks was 1.0 microliters per square centimeter.

The image density of the images formed was measured with a densitometer (Macbeth RD-915 available from Macbeth Process Measurements Co.). Table 2 shows the measurement results of the aqueous inks 1 to 7 that use the self-dispersion pigment B. Table 3 shows the measurement results of the aqueous inks 8 to 10 that use the self-dispersion pigment A. Herein, the image density shown in Table 2 is a relative value when the image density of a recorded image formed on each of the recording media in single-pass printing in Comparative Example 1 that uses the aqueous ink 6 was assumed to be 1.00. The image density shown in Table 3 is a relative value when the image density of a recorded image formed on each of the recording media in single-pass printing in Comparative Example 3 that uses the aqueous ink 9 was assumed to be 1.00. In Comparative Example 1, the absolute value of image density when an image was formed on SW-101 in single pass printing was 1.20, and the absolute value of image density when an image was formed on Xerox 4200 in single pass printing was 1.08. In Comparative Example 3, the absolute value of image density when an image was formed on SW-101 in single pass printing was 1.21, and the absolute value of image density when an image was formed on Xerox 4200 in single pass printing was 1.18.

TABLE 2

| | | | | | | Surface | | Image density | | | |
|---|---|---|---|---|---|---|---|---|---|---|---|
| | | pKa₂ − | pKa₂ − | pKa₂ + | | tension | Dispersion | SW-101 | | Xerox 4200 | |
| | Ink | pKa₁ | 1.5 | 0.5 | pH | (mN/m) | stability | SS | DS | SS | DS |
| Ex. 1 | 1 | 3.6 | 4.6 | 6.6 | 5.6 | 30.0 | A | 1.08 | 1.15 | 1.10 | 1.15 |
| Ex. 2 | 2 | 3.6 | 4.6 | 6.6 | 6.6 | 30.0 | A | 1.03 | 1.11 | 1.06 | 1.08 |
| Ex. 3 | 3 | 3.6 | 4.6 | 6:6 | 5.6 | 30.0 | A | 1.06 | 1.12 | 1.09 | 1.12 |
| Ex. 4 | 4 | 3.6 | 4.6 | 6.6 | 5.6 | 30.0 | A | 1.13 | 1.23 | 1.26 | 1.31 |
| Ex. 5 | 5 | 3.6 | 4.6 | 6.6 | 5.6 | 30.0 | A | 1.17 | 1.26 | 1.23 | 1.33 |
| C.E. 1 | 6 | 3.6 | 4.6 | 6.6 | 8.2 | 30.0 | A | 1.00 | 1.06 | 1.00 | 1 02 |
| C.E. 2 | 7 | 3.6 | 4.6 | 6.6 | 4.5 | 30.0 | B | — | — | — | — |

Ex.: Example
C.E.: Comparative Example
SS: Single ink supply
DS: Divided ink supply

TABLE 3

| | | | | | | Surface | | Image density | | | |
|---|---|---|---|---|---|---|---|---|---|---|---|
| | | pKa₂ − | pKa₂ − | pKa₂ + | | tension | Dispersion | SW-101 | | Xerox 4200 | |
| | Ink | pKa₁ | 1.5 | 0.5 | pH | (mN/m) | stability | SS | DS | SS | DS |
| Ex. 6 | 8 | 3.0 | 4.5 | 6.4 | 5.6 | 30.0 | A | 1.03 | 1.09 | 1.03 | 1.05 |
| C.E. 3 | 9 | 3.0 | 4.5 | 6.4 | 7.0 | 30.0 | A | 1.00 | 1.05 | 1.00 | 1.02 |
| C.E. 4 | 10 | 3.0 | 4.5 | 6.4 | 4.0 | 30.0 | B | — | — | — | — |

Ex.: Example
C.E.: Comparative Example
SS: Single ink supply
DS: Divided ink supply

As shown in Tables 2 and 3, image density was decreased for the aqueous ink 6 of

Comparative Example 1 in which the pH of the ink was adjusted to 8.2, which was a value more than pKa₂+0.5, and for the aqueous ink 9 of Comparative Example 3 in which the pH of the ink was adjusted to 7.0, which was a value more than pKa₂+0.5. On the other hand, the aggregation and precipitation of pigment were observed for the aqueous ink 7 of Comparative Example 2 in which the pH of the ink was adjusted to 4.5, which was a value equal to or less than pKa₂−1.5, and for the aqueous ink 10 of

Comparative Example 4 in which the pH of the ink was adjusted to 4.0, which was a value equal to or less than pKa₂−1.5. This may be because, since the pH of the aqueous ink was a value equal to or less than pKa₂−1.5, the pigment in the state 1 shown in FIG. 1 became dominant.

Furthermore, as shown in Tables 2 and 3, it was confirmed that, by adjusting the pH of the aqueous ink to a value of pKa₂−1.5 or more and pKa₂+0.5 or less, the image density of a recorded image was significantly improved. This may be because, by adjusting the pH of the aqueous ink to a value of pKa₂−1.5 or more and pKa₂+0.5 or less, the pigments in the states 2 and 3 shown in FIG. 1 were suitably present in a mixed manner, the solid-liquid separation when the ink landed on plain paper proceeded immediately, and the pigment was fixed in the outer layer of the plain paper. As is clear from the comparison between Example 1 and Example 2 in Table 2, higher image density was achieved in the case where the pH of the aqueous ink was low. The pH of the aqueous ink in Example 1 was adjusted to pKa₂ (6.1 in this Example) −0.5, and the ratio of the pigment in the state 2 to that in the state 3 shown in FIG. 1 was about 4:1. In contrast, the pH of the aqueous ink in Example 2 was adjusted to pKa₂ (6.1 in this Example) +0.5, and the ratio of the pigment in the state 2 to that in the state 3 shown in FIG. 1 was about 1:4. For the pigment in the state 2 shown in FIG. 1, the solid-liquid separation when the ink lands on plain paper proceeds immediately, and thus the pigment is fixed in the outer layer of plain paper. However, for the pigment in the state 3, the solid-liquid separation is inhibited, and thus the pigment is fixed at the depths of plain paper. It is considered that the aqueous ink in Example 2 has lower image density than that in Example 1 because the ratio of the pigment in the state 3 is increased.

As is apparent from Tables 2 and 3, by comparing an image-forming method (single ink supply) to another image-forming method (divided ink supply) without changing the composition and pH of the aqueous inks, the types of pH-adjusting agent, and the types of paper, higher image density was achieved through the divided ink supply rather than the single ink supply. As a result, it is understood that, when higher image density is required, the divided ink supply is suitably employed as an image-forming method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2009-179633, filed Jul. 31, 2009, and No.2010-130296, filed Jun. 7, 2010 which are hereby incorporated by reference herein in their entirety.

1. An aqueous ink having a surface tension of 34 mN/m or less comprising:
a self-dispersion pigment; and
water,
wherein the self-dispersion pigment has a plurality of pKa values that are 8.0 or less,
assuming that the lowest pKa value among the plurality of pKa values is pKa and the highest pKa value among the plurality of pKa values is pKa₂, pKa₁ and pKa₂ satisfy Mathematical formula (1) below, and a pH value of the aqueous ink satisfies Mathematical formula (2) below.
[Math.1]
2.0≦pKa₂−pKa₁ (1)
[Math.2]
pKa₂−1.5≦pH≦pKa₂+0.5 (2)

2. The aqueous ink according to Claim I , further comprising a water-soluble compound having a hydrophilic/hydrophobic coefficient of 0.26 or more, the hydrophilic/hydrophobic coefficient being defined by Formula (A) below.
Hydrophilic/hydrophobic coefficient=((water activity value of:20% aqueous solution)−(mole fraction of 20% aqueous solution)/}1−(mole fraction of 20% aqueous solution)} Formula (A)

3. The aqueous ink according to claim 1, further comprising an organic acid or an inorganic acid having a pKa value that is equal to or lower than a pH value of the aqueous ink, or a salt of the organic acid or the inorganic acid.

4. An inkjet image-forming method comprising a step of supplying the aqueous ink according to claim 1 to plain paper in a constant amount of 0.5 pl or more and 6.0 pl or less through an inkjet technique to form an image.

5. The inkjet image-forming method according to claim 4, wherein, when an image having an area with a duty of 80% or more and a total ink-supply amount of 5.0 microliters per square centimeter or less is formed in a basic matrix where the image is to be formed, supply of the ink is performed a plurality of times in a divided manner and the amount of the ink per supply is 0.7 microliters per square centimeter or less.

6. The inkjet image-forming method according to claim 4, wherein supply of the ink is performed through action of thermal energy,
